(19) United States
(12) Patent Application Publication
(10) Pub. No.: US 2020/0228758 A1
(43) Pub. Date: Jul. 16, 2020

(54) SMART DOORBELL SYSTEM

(71) Applicant: Yuhua WANG, Beijing (CN)

(72) Inventor: Yuhua WANG, Beijing (CN)

(21) Appl. No.: 16/626,646

(22) PCT Filed: Jun. 27, 2018
(86) PCT No.: PCT/CN2018/093031

§ 371 Date: Dec. 26, 2019

(30) Foreign Application Priority Data
Jun. 28, 2017 (CN) 201720759058.3

(51) Int. Cl. H04N 7/18; H04N 5/232

(52) U.S. Cl. CPC H04N 7/186; H04N 5/232411; H04N 5/23206

(57) ABSTRACT

Disclosed is a smart doorbell system. The smart doorbell system comprises an outdoor smart doorbell host, an indoor ringer, a server on a network, and a mobile smart terminal. The smart doorbell host comprises a central processing unit, a camera, a passive infrared sensor, a microwave sensor, a speaker, a microphone, a local storage module, a wireless communication module, and an internet communication module, wherein the central processing unit is connected to each of other units. The smart doorbell host is connected to the ringer in a wired or wireless manner, and wirelessly communicates with the server through the internet communication module. The mobile smart terminal also wirelessly communicates with the server through the internet communication module.

### TECHNICAL FIELD

The present disclosure relates to a field of domestic security, and in particular to a smart doorbell system with camera.

### BACKGROUND ART

Currently, in the field of smart doorbell with camera, the doorbell not only serves to notify a houseowner of a visitor's access but also partially serves as a security camera to detect whether there are visitors who are active within a monitored area thereof. If there are visitors who are active, the camera takes photos or records videos to notify the houseowner. The method used by the camera to detect the visitors mainly depends on an infrared sensor that detects infrared rays generated from a human body. However, false alarms are inevitable in a case where hot air flows within the monitored area or other objects or devices that generate heat are within the monitored area because the detection is affected by these factors. Another detection method is to determine whether there is a visitor by analyzing change of pictures recorded by the camera, and one disadvantage of this method is that the camera needs to be in a working state all the time, which is unfavorable to electricity saving.

### SUMMARY

In order to overcome the shortcomings and deficiencies in the prior art, the present disclosure provides a smart doorbell system with camera that detects visitors more accurately and reduces false alarms, and a control method of the smart doorbell system.

Solution 1: The smart doorbell system includes a smart doorbell host disposed outdoors, a ringer disposed indoors, a server on a network, and a mobile smart terminal, the smart doorbell host including: a central processing module, a camera, a passive infrared sensor, a microwave sensor, a speaker, a microphone, a wireless communication module, and an internet communication module, wherein the camera, the passive infrared sensor, the microwave sensor, the speaker, the microphone, the wireless communication module, and the internet communication module are respectively connected to the central processing module; the smart doorbell host is in wired connection with the ringer or wirelessly communicates with the ringer through the wireless communication module; the smart doorbell host wirelessly communicates with the server through the internet communication module, and the mobile smart terminal also wirelessly communicates with the server.

Solution 2: The smart doorbell system includes a smart doorbell host disposed outdoors, a ringer and a wireless router disposed indoors, a server on a network, and a mobile smart terminal, the smart doorbell host including: a central processing chip, a camera, a passive infrared sensor, a microwave sensor, a video processing chip, an audio processing chip, a speaker, a microphone, a wireless communication module, and an internet communication module, wherein the passive infrared sensor and the microwave sensor are respectively connected to the central processing chip; the speaker and the microphone are respectively connected to the audio processing chip; the camera, the audio processing chip, the central processing chip, the wireless communication module, and the internet communication module are respectively connected to the video processing chip; the smart doorbell host is in wired connection with the ringer or wirelessly communicates with the ringer through the wireless communication module; the smart doorbell host wirelessly communicates with the server through the internet communication module and the wireless router, and the mobile smart terminal also wirelessly communicates with the server.

### BRIEF DESCRIPTION OF THE DRAWINGS

FIG. 1 is a block schematic diagram of Solution 1 of a smart doorbell system of the present disclosure.

FIG. 2 is a block schematic diagram of Solution 2 of the smart doorbell system of the present disclosure (in which the smart doorbell system is connected to a network through a wireless router).

FIG. 3 is a structural block schematic diagram of Solution 1 of a smart doorbell host of the present disclosure.

FIG. 4 is a structural block schematic diagram of Solution 2 of the smart doorbell host of the present disclosure.

### DETAILED DESCRIPTION OF THE SPECIFIED EMBODIMENTS

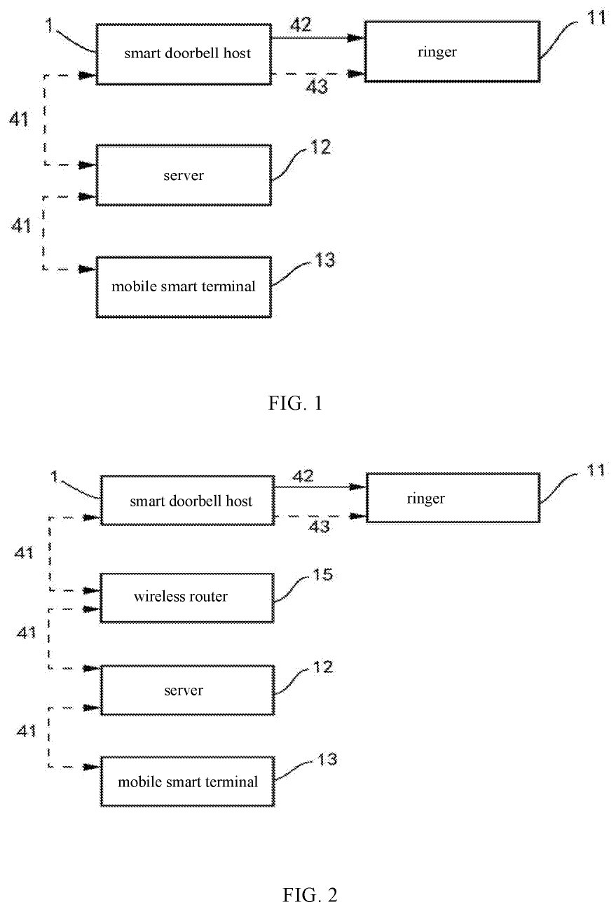

FIG. 1 is a block schematic diagram of Solution 1 of a smart doorbell system of the present disclosure. As shown in FIG. 1, the smart doorbell system of the present disclosure includes a smart doorbell host 1 disposed outdoors, a ringer 11 disposed indoors, a server 12 on a network, and a mobile smart terminal 13 (e.g., a smart mobile phone or a tablet PC). The smart doorbell host 1 wirelessly communicates with the ringer 11 as indicated by a dashed line unidirectional arrow 43, or is in wired connection with the ringer 11 as indicated by a solid line unidirectional arrow 42. A dashed line bidirectional arrow 41 indicates that the smart doorbell host 1 wirelessly communicates with the server 12 on the network and the server 12 on the network is wirelessly communicates with the mobile smart terminal 13.

The server on the network is used to store photos or videos of visitors sent by the smart doorbell host and notify the mobile smart terminal device such as a smart mobile phone or a tablet PC of a user (a houseowner).

The ringer is used to play a bell sound or a piece of music when the doorbell host detects access of a visitor or when the visitor presses a call button to remind the user indoors of the visitor's access.

The mobile smart terminal includes, but not limited to, a smart mobile phone and a tablet PC. The mobile smart terminal is installed with a control APP for receiving information sent by the server on the network. For example, if a visitor presses a call button or a visitor who is active is detected within a monitored area, the houseowner can view pictures of the camera in the APP, or choose to establish an audio or video communication with the visitor, or view audio and video data that have been recorded earlier.

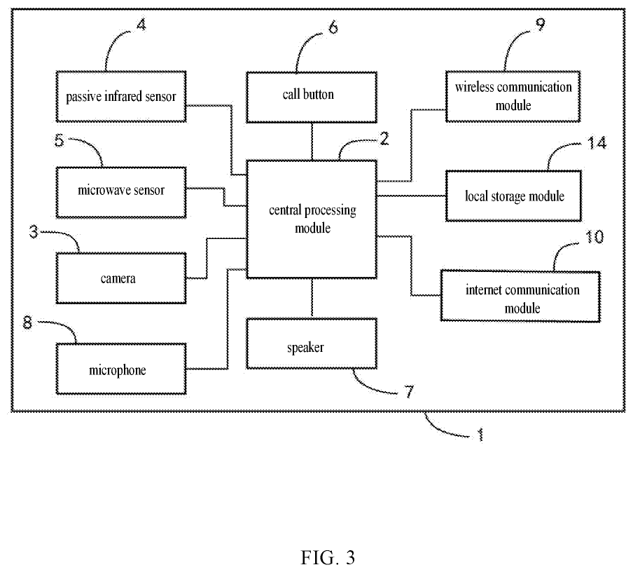

FIG. 3 is a structural schematic diagram of Solution 1 of the smart doorbell host of the present disclosure. As shown in FIG. 3, the smart doorbell host 1 includes a central processing module 2, a camera 3, a passive infrared sensor 4, a microwave sensor 5, a call button 6, a speaker 7, a microphone 8, a wireless communication module 9, an internet communication module 10, and an optional local storage module 14. The camera 3, the passive infrared sensor 4, the microwave sensor 5, the call button 6, the speaker 7, the microphone 8, the wireless communication module 9, the internet communication module 10, and the optional local storage module 14 are connected to the central processing module 2; the smart doorbell host 1 wirelessly communicates with the ringer 11 through the wireless communication module 9; the smart doorbell host 1 is in communication with the server 12 on the network through the internet communication module 10, and the mobile smart terminal 13 is also in communication with the server 12 via the Internet.

After the doorbell host 1 is enabled, in order to save electricity, the camera 3 is in a non-working state (i.e., an asleep state). When a visitor arrives and presses the call button 6 outside the door, the central processing module 2 receives a command to wake up the camera 3 to work, then the camera 3 starts recording videos and communicates with the network server 12 through the internet communication module 10 to notify the network server 12 that the visitor pressed the call button 6, and the server 12 pushes information to the mobile smart terminal 13 of the houseowner. While the visitor is pressing the call button 6, the smart doorbell host 1 is connected to the indoor ringer 11 through the wireless communication module 9 (or is in wired connection with the ringer 11 as indicated by the solid line unidirectional arrow 42), and the ringer 11 is caused to play a pre-set music or bell sound to remind the user indoors that the visitor pressed the call button 6.

The server 12 pushes the information indicating that the visitor pressed the call button 6 to the mobile smart terminal 13 of the houseowner, for example, the houseowner's smart mobile phone or tablet PC, etc. After receiving the information pushed by the server 12, the houseowner knows that there is a visitor, at this time he can open the corresponding APP in the mobile smart terminal 13 to watch the video data of the visitor at the door, and can also start a video talk with the visitor using the camera 3, the microphone 8 and the speaker 7. Even if the houseowner is not at home, he can still receive information about access of a visitor as long as the mobile smart terminal 13 is connected to the Internet at the place where he is located.

It should be noted that no matter whether there is a visitor who is active within the monitored area of the smart doorbell or whether he presses the call button, the houseowner of the smart doorbell can manipulate the camera to work using the corresponding APP in the mobile smart terminal through the network server at any time.

The above method of use is to use the smart doorbell as a normal visual doorbell, which is a first working mode of the smart doorbell of the present disclosure. The smart doorbell of the present disclosure also has a second working mode. When the smart doorbell is set to the second working mode, the smart doorbell of the present disclosure also serves as a security monitoring camera, which is advantageous in electricity saving and video storage space saving as described below.

When the smart doorbell of the present disclosure is in the second working mode, after the doorbell host 1 is enabled, the camera 3 is caused to be in a non-working asleep state in order to save electricity. When there is a visitor who is active within the monitored area of the doorbell host 1, the passive infrared sensor 4 detects change of an infrared spectrum of a human body and transmits information to the central processing module 2, and the central processing module 2 determines that there is a visitor and causes the camera 3 to work and start recording videos for a region in front of the camera. Nonetheless, since the passive infrared sensor 4 is susceptible to disturbance from various heat sources and light sources, it would generate false alarms. Thus, the doorbell host 1 of the present disclosure is further provided with the microwave sensor 5 which actively emits electromagnetic waves. When someone enters into a range of the electromagnetic waves, the electromagnetic waves generate a specific disturbance and reflection. When the electromagnetic wave received by the microwave sensor 5 changes, the microwave sensor 5 determines that there is a visitor, and transmits information to the central processing module 2. The central processing module 2 determines that there is a visitor who is active within the monitored area only when the information of the passive infrared sensor 4 and that of the microwave sensor 5 are received by the central processing module 2 at the same time. Then the camera 3 is activated by the central processing module 2 into a working state to record videos and communicate with the server 12 through the internet communication module 10 to notify the server 12 that there is a visitor who is active within the monitored area. The server 12 pushes the information to the mobile smart terminal 13 of the houseowner, and the houseowner can view conditions within the monitored area through the mobile smart terminal 13 upon knowing the information. The doorbell host 1 may also be connected to the indoor ringer 11 through the wireless communication module 9 so that the ringer 11 plays a preset music or bell sound to remind the user indoors that someone is active within the monitored area of the smart doorbell host 1. When the camera 3 is activated, the recorded videos may be stored in the local storage module 14 in the smart doorbell host 1, and may be simultaneously transmitted to the server 12 and stored thereon for later viewing. When no one is detected by the passive infrared sensor 4 and the microwave sensor 5 within the monitored area, the central processing module 2 deactivates the camera 3 to save electricity and storage space.

It can be seen from the above that when the smart doorbell is set to the second working mode, the smart doorbell host 1 may not include the call button 6, and at this time, the passive infrared sensor 4 and the microwave sensor 5 cooperate with each other to determine whether there is a visitor who is active within the monitored area and whether to activate the camera 3.

FIG. 2 is a block schematic diagram of Solution 2 of the smart doorbell system (connected to the network through a wireless router) of the present disclosure. As shown in FIG. 2, Solution 2 differs from Solution 1 of FIG. 1 in that a smart doorbell host 21 is wirelessly connected to a wireless router 15 as indicated by the dashed line bidirectional arrow 41, and is further connected to the server 12 (on the network).

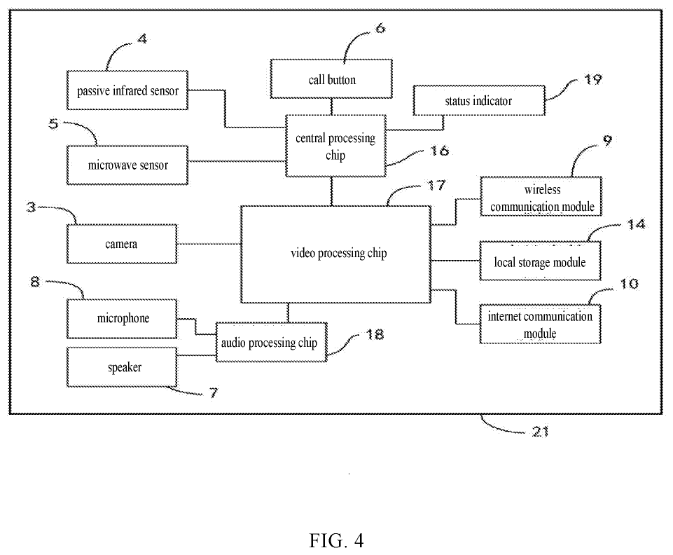

FIG. 4 is a structural block schematic diagram of Solution 2 of the smart doorbell host 21 of the present disclosure. The smart doorbell host 21 includes: a central processing chip 16, the camera 3, the passive infrared sensor 4, the microwave sensor 5, the call button 6, a status indicator 19, a video processing chip 17, an audio processing chip 18, the speaker 7, the microphone 8, the wireless communication module 9, the internet communication module 10, an optional status indicator 19, and an optional local storage module 14, wherein the passive infrared sensor 4, the microwave sensor 5, the optional call button 6 and the optional status indicator 19 are respectively connected to the central processing chip 16; the speaker 7 and the microphone 8 are respectively connected to the audio processing chip 18; the camera 3, the audio processing chip 18, the central processing chip 16, the wireless communication module 9, the internet communication module 10 and the optional local storage module 14 are respectively connected to the video processing chip 17; the smart doorbell host 21 is connected to the ringer 11 or wirelessly communicates with the ringer 11 through the wireless communication module 9; the smart doorbell host 21 wirelessly communicates with the server 12 through the internet communication module 10 and the wireless router 15, and the mobile smart terminal 13 also wirelessly communicates with the server 12.

As described above, when the smart doorbell is set to the second working mode, the smart doorbell host 21 may not include the call button 6, and at this time, the passive infrared sensor 4 and the microwave sensor 5 cooperate with each other to determine whether there is a visitor who is active within the monitored area and whether to activate the camera 3.

As compared to Solution 1 of the smart doorbell host 1, the central processing module 2 in the smart doorbell host 1 is further decomposed into a combination of specific chips, that is, the central processing chip 16, the video processing chip 17, and the audio processing chip 18 in Solution 2 of the smart doorbell host 21. There is no fundamental change in working principles of Solutions 1 and 2. That is, Solution 2 of the smart doorbell host 21 has the same working principle as that of Solution 1 of the smart doorbell host 1, except for some differences in manners in which the specific devices are configured. Therefore, the working modes of Solution 2 of the smart doorbell host 21 and Solution 1 of the smart doorbell host 1 are substantially the same.

1. A smart doorbell system comprising:
a smart doorbell host disposed outdoors, a ringer disposed indoors, a server on a network, and a mobile smart terminal, the smart doorbell host comprising: a central processing module, a camera, a passive infrared sensor, a microwave sensor, a speaker, a microphone, a wireless communication module, and an internet communication module, wherein the camera, the passive infrared sensor, the microwave sensor, the speaker, the microphone, the wireless communication module, and the internet communication module are respectively connected to the central processing module; the smart doorbell host is in wired connection with the ringer or wirelessly communicates with the ringer through the wireless communication module; the smart doorbell host wirelessly communicates with the server through the internet communication module, and the mobile smart terminal wirelessly communicates with the server.

2. The smart doorbell system of claim 1, wherein the smart doorbell host further comprises a call button that is connected to the central processing module.

3. The smart doorbell system of claim 1, wherein the smart doorbell host further comprises a local storage module that is connected to the central processing module, the local storage module storing audio data recorded by the microphone and video data recorded by the camera, the server receiving and storing the audio data recorded by the microphone and the video data recorded by the camera which are uploaded.

4. A smart doorbell system comprising:
a smart doorbell host disposed outdoors, a ringer and a wireless router disposed indoors, a server on a network, and a mobile smart terminal, the smart doorbell host comprising: a central processing chip, a camera, a passive infrared sensor, a microwave sensor, a video processing chip, an audio processing chip, a speaker, a microphone, a wireless communication module, and an internet communication module, wherein the passive infrared sensor and the microwave sensor are respectively connected to the central processing chip; the speaker and the microphone are respectively connected to the audio processing chip; the camera, the audio processing chip, the central processing chip, the wireless communication module, and the internet communication module are respectively connected to the video processing chip; the smart doorbell host is in wired connection with the ringer or wirelessly communicates with the ringer through the wireless communication module; the smart doorbell host wirelessly communicates with the server through the internet communication module and the wireless router, and the mobile smart terminal wirelessly communicates with the server.

5. The smart doorbell system of claim 4, wherein the smart doorbell host further comprises a call button that is connected to the central processing chip.

6. The smart doorbell system of claim 4, wherein the smart doorbell host further comprises a status indicator that is connected to the central processing chip.

7. The smart doorbell system of claim 4, wherein the smart doorbell host further comprises a local storage module that is connected to the video processing chip, the local storage module storing audio data recorded by the microphone and video data recorded by the camera, the server receiving and storing the audio data recorded by the microphone and the video data recorded by the camera which are uploaded.

8. The smart doorbell system of claim 4, wherein the smart doorbell host and the ringer are powered by a battery or an alternating current.

9. The smart doorbell system of claim 4, wherein the camera is in an asleep state to save electric energy at a usual time, and the passive infrared sensor and the microwave sensor or the call button or the server on the network wakes up the camera such that the camera starts to work.

10. The smart doorbell system of claim 9, wherein when the camera is in a working state, the camera and the microphone allow a visitor and a houseowner holding the mobile smart terminal to view each other and have a talk.

11. The smart doorbell system of claim 10, wherein the mobile smart terminal is used to view previously recorded audio and video data.

12. The smart doorbell system of claim 1, wherein the smart doorbell host and the ringer are powered by a battery or an alternating current.

13. The smart doorbell system of claim 1, wherein the camera is in an asleep state to save electric energy at a usual time, and the passive infrared sensor and the microwave sensor or the call button or the server on the network wakes up the camera such that the camera starts to work.

14. The smart doorbell system of claim 13, wherein when the camera is in a working state, the camera and the microphone allow a visitor and a houseowner holding the mobile smart terminal to view each other and have a talk.

15. The smart doorbell system of claim 14, wherein the mobile smart terminal is used to view previously recorded audio and video data.
